(19) United States
(12) Patent Application Publication
(10) Pub. No.: US 2007/0165227 A1
(43) Pub. Date: Jul. 19, 2007

(54) Device and method for object recognition for an automotive safety device

(75) Inventors: Hermann Bauer, Heidenheim (DE); Gunter Fendt, Schrobenhausen (DE); Josef Barenweiler, Zirndorf (DE); Helmut Steurer, Gerolsbach-Junkenhofen (DE); Hermann Kublbeck, Schrobenhausen (DE)

Correspondence Address: CONTINENTAL TEVES, INC., ONE CONTINENTAL DRIVE, AUBURN HILLLS, MI, 48326-1581, US

(73) Assignee: Conti Temic Microelectronic GMBH

(21) Appl. No.: 10/579,346

(22) PCT Filed: Oct. 8, 2004
(86) PCT No.: PCT/DE04/02231

§ 371 Date: Feb. 22, 2007

(30) Foreign Application Priority Data
Nov. 13, 2003 (DE) 103 53 001.0

(51) Int. Cl. G01J 4/00

(52) U.S. Cl. 356/369

(57) ABSTRACT

The invention relates to a device for object recognition for an automotive passenger protection system, comprising a signal source (10), adapted to generate at least one electromagnetic wave (12), and a receiver (14) for the at least one electromagnetic wave (18) reflected by an obstacle (16). The inventive device is provided with an evaluation unit (20) that is adapted to evaluate the polarization of the at least one electromagnetic wave (18) reflected by the obstacle (16) and received by the receiver (14) and to generate at least one evaluation signal (22). The inventive device and method allow for obtaining additional information on the obstacle such as its surface structure and using the same for the automotive passenger protection system.

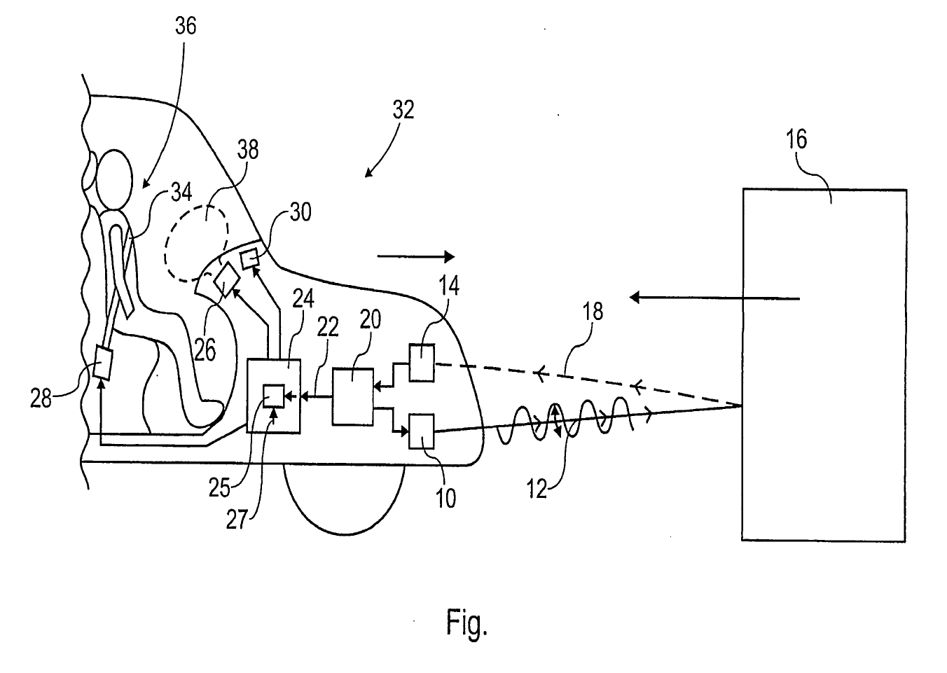

The invention relates to a device for object recognition for an automotive safety device according to claim 1 and to a corresponding method according to claim 14.

Systems for an active driver's support gain more and more significance in automotive engineering. For further improvement of the safety level, meanwhile “foresighting” safety systems are increasingly used, i.e. systems, which optically detect the vehicle environment and which incorporate the thus obtained data and information into safety concepts.

At the moment mainly so-called cV (closing velocity)—sensors are put to the test. CV-sensors of this type serve for detecting a delta-speed between a motor vehicle and an obstacle and work on the basis of laser or radar beams, respectively. For detecting the delta-speed the “delta-running time” of emitted signals is measured until the signals reflected at the object or obstacle to be measured are received.

However, with this method it is disadvantageous that it can generate only limited significant data and information relevant for safety. The only directly generated information is the relative differential speed of an object or of an obstacle and of their distance to the sensor. Further information on the obstacle, such as for example the nature of the object (e.g. cardboard or vehicle) are not obtained by means of this method. Only the speed of the obstacle can be directly detected on the basis of the appropriate speed of the cV-sensor.

As in particular information on the nature and mass of the obstacle play an important role for the process of a possible collision of a motor vehicle with the obstacle, the detection and incorporation of this information into the decisive courses of action of a safety concept in the motor vehicle would be of great benefit.

It is, therefore, the object of the present invention to propose a device and a method for object recognition for an automotive safety device, which in addition to the relative speed generate at least one further information, which can be advantageously evaluated by the automotive safety device.

This object is achieved by a device and a method for object recognition for an automotive safety device according to the features of claim 1 or 14, respectively. Further embodiments of the invention result from the dependent claims.

A substantial thought of the invention is based on the evaluation of the polarization of an electromagnetic wave reflected at an obstacle, such as for example of a laser beam. The polarization allows for obtaining information on the type of the obstacle, in particular on its surface structure. This is based on the conclusion that a polarized electromagnetic wave such as for example laser light is reflected at different materials with different rotation angles in terms of the polarization level, i.e. on the fact that the rotation angle of the polarization depends from the material in case of a reflection. This rotation of the polarization level of the laser light reflected by the recording material can be measured with the aid of suitable optical and electronic devices and can be converted into corresponding signals.

The relation relates to a device for object recognition for an automotive passenger protection system, comprising a signal source, adapted to generate at least one electromagnetic wave, and a receiver for the at least one electromagnetic wave reflected by an obstacle. The inventive device is provided with an evaluation unit that is adapted to evaluate the polarization of the at least one electromagnetic wave reflected by the obstacle and received by the receiver and to generate at least one evaluation signal. The at least one evaluation signal generated in this way can be used as a release or information signal for a safety device of the automotive passenger protection system. The evaluation unit is preferably adapted to determine the rotation angle of the polarization between the emitted at least one electromagnetic wave reflected by the obstacle and received by the receiver.

As an alternative or in addition the evaluation unit can be adapted to determine the type of polarization of the at least one electromagnetic wave reflected by the obstacle and received by the receiver.

For further improving the accuracy of the evaluation, the evaluation unit can be adapted to determine the wavelength of the at least one electromagnetic wave reflected by the obstacle and received by the receiver.

For a particularly exact evaluation the signal source can be adapted to change the polarization, in particular the angle of polarization, the level of polarization and/or the type of polarization of the generated at least one electromagnetic wave, in particular to generate at least two differently polarized electromagnetic waves (12).

Further, the signal source can be adapted to change the wavelength of the generated at least one electromagnetic wave, in particular to generate at least two electromagnetic waves (12) with different wavelengths.

In particular the evaluation unit is adapted to determine on the basis of the evaluated polarization, in particular of the angle of polarization, the level of polarization and/or the type of polarization and/or wavelength to determine a surface structure of the obstacle, in particular to evaluate the properties of polarization of at least two electromagnetic waves with different wavelengths, preferably to evaluate their ratio.

In a preferred form of embodiment the evaluation unit is adapted to generate as an evaluation signal an information signal for influencing and/or controlling the automotive passenger protection system on the basis of the information on the determined surface structure.

Preferably, a control unit of the passenger protection system comprises a comparison unit, which compares the evaluation signal with a threshold value, the control unit being adapted to trigger at least one safety device when the signal exceeds the threshold value.

In a particularly preferred form of embodiment a control unit of the passenger protection system is adapted to change dependent on the evaluation signal a threshold value for activating a safety device. For example the threshold value for triggering an airbag can be lowered, if a concrete block is detected as an obstacle by the inventive device.

In particular, the device is used in a pre-crash-system, a cV-system, an ADC-system, a warning system for obstacle and/or slippery ice and/or a recognition system for roadway conditions.

Further, the receiver can be adapted to change its receiving characteristics controlled by the evaluation unit. For example it can be controlled in such manner that a light collector of the receiver is adjusted to different polarization levels. In this way the reflection behavior of an obstacle with different polarization levels can be checked, whereby more information on the nature of the obstacle can be detected.

The signal source is preferably adapted to generate at least one linear, circular and/or elliptically polarized electromagnetic wave, in particular with a wavelength in the region of visible light. Thus, it is for instance possible to emit laser beams with different polarization directions and to evaluate their potential different reflections at the obstacle. It is also possible to emit a non-polarized electromagnetic wave and to analyze its reflection at the obstacle with regard to the polarization properties, in particular in terms of the polarization portions and directions contained in the reflected wave and to compare the information thus obtained with the stored information on polarizations of reflected waves at certain materials such as concrete, wood, metal, cardboard or the like.

Furthermore, the invention relates to a method for object recognition for an automotive passenger protection system, in which at least one electromagnetic wave is generated and emitted, and the at least one electromagnetic wave reflected by an obstacle is received. In accordance with the invention the polarization of the at least one electromagnetic wave, reflected by the obstacle and received, is evaluated and at least one evaluation signal is generated, in particular to obtain additional information on the obstacle apart from the relative speed and the distance to the obstacle.

In particular the rotation angle of the polarization between the at least one electromagnetic wave, which is reflected by the obstacle and received and emitted, is determined.

Beyond this, the type of polarization of the at least one electromagnetic wave, reflected by the obstacle and received, can be determined.

For further improvement of the evaluation the wavelength of the at least one electromagnetic wave, reflected by the obstacle and received, can be determined.

Preferably, the polarization, in particular the angle of polarization, the level of polarization and/or the type of polarization of the generated at least one electromagnetic wave can be changed, in particular two or more electromagnetic waves with different polarizations are emitted to obtain sufficient information for determining the nature of the obstacle.

Furthermore, the wavelength of the generated at least one electromagnetic wave can be changed, in particular two or more electromagnetic waves with different wavelengths can be emitted.

On the basis of the evaluated polarization, in particular of the angle of polarization, the level of polarization and/or the type of polarization and/or wavelength a surface structure of the obstacle can be determined.

In particular, on the basis of the information on the determined surface structure the automotive passenger protection system is controlled.

For a further improvement of the accuracy, the emitting characteristics when emitting and/or the receiving characteristics when receiving the at least one electromagnetic wave reflected by the obstacle can be changed.

Typically, at least one linear, circular and/or elliptically polarized electromagnetic wave, in particular with a wavelength in the region of visible light, is generated.

Further advantages and potential applications of the present invention can be taken from the ensuing description taken in conjunction with the example of embodiment shown in the single drawing.

In the description, the claims, the abstract and in the drawing the terms and associated reference numerals used in the list of reference numerals added at the end are used.

The sole FIGURE shows an automobile 32 with a passenger 36, who in case of a crash or an accident is protected by a safety belt 34 and an airbag 38. In case of a crash the airbag 38 is ignited or activated by an airbag control system (comprising a gas generator) 26 and is shown in dashed lines in its blown-up state. The safety belt 34 is controlled by a belt tensioner 28, which tensions the safety belt 34 in case of a crash. For the passenger's safety, if applicable, furthermore, an obstacle warning display 30 is provided in the region of the dashboard of the automobile 32, which acoustically and optically warns in case of an approaching obstacle or an imminent danger.

The airbag control system 26, belt tensioner 28 and obstacle warning display 38 are part of an automotive passenger protection system and are controlled by a control unit of the automotive passenger protection system 24. For this purpose, the control unit 24 processes input signals from sensors, such as for instance from speed and/or accelerating sensors and/or signals from vehicle information busses, such as e.g. a CAN-bus and from an obstacle sensor, which is described in detail hereinafter.

The obstacle sensor substantially comprises a laser 10 as a signal source, which generates a laser beam 14 in the driving direction of the automobile 32, a receiving diode with an upstream polarization filter 14 as a receiver for the laser beam 18 reflected at an obstacle 16 and an evaluation processor 20 for controlling the laser 10 and evaluating output signals of the receiving diode with upstream polarization filter 14.

The laser 10 generates a substantially monochromatic and linearly polarized laser beam. Depending on the nature of the obstacle 16, the polarization of the laser beam 12 is rotated by a certain angle in case of a reflection. Therefore, the polarization level of the reflected laser beam 18 as a rule has a different angle than the polarization level of the emitted laser beam 12. This rotation is detected by the receiving diode with the upstream polarization filter 14, i.e. a corresponding output signal is generated, which is processed by the evaluation processor 20.

With the result of the evaluation the evaluation processor 20 in turn generates an evaluation signal 22. The evaluation signal 22 is transferred to the control unit 24 as a sensor signal. In the control unit 24 a comparison circuit 25 compares the received evaluation signal 22 with a predetermined threshold value 27 or with a stored information, which, depending on type and scope, is preferably deposited in a one- or multi-dimensional characteristic diagram. Such a characteristic diagram can be generated e.g. by special surface sensors, which serve for scanning the environment in the front region of the automobile.

The evaluation signal does not serve for directly activating safety devices such as the airbag control system or gas generator 26 and the belt tensioner 28, but as a so-called release or information signal for the control unit 24, so that it can initiate/activate an ignition of the airbag 38 and/or the belt tensioner 28.

However, it is not excluded, but included in the present invention, that as far as a so-called release signal is transferred to the control unit 24 as an evaluation signal 22, it can serve for example as a plausibility signal for the control unit 24 (or for example for an airbag control device) for the automotive passenger protection system, so that on the basis of the release decision the automotive passenger protection system has taken, it can justify this decision by means of an “AND”-relation with the evaluation signal 22.

As far as a so-called information signal or control signal is emitted as an evaluation signal 22, it can serve for example for accordingly changing the threshold values 27 or release thresholds provided in the control unit 24 or for adapting them to the situation to be expected. Concretely, by the evaluation signal 22 the threshold value 27 can be influenced, i.e. adapted to the type of the obstacle 16.

Finally, the evaluation signal 24 can control also directly determined safety devices of the automotive passenger protection system, such as for example a warning signal lamp control or the obstacle warning display 30. In this case the signal processing or signal pre-processing incl. comparison of threshold or sample (when including a characteristic diagram) is preferably effected already in the evaluation processor 20.

If in the shown example of embodiment the level of the evaluation signal 22 exceeds the predetermined threshold value 27 or if on the basis of a comparison with the stored information of the one- or multidimensional characteristic diagram a safety critical situation is indicated, the control unit activates corresponding safety devices in the automobile 32 or generates control and/or release signals for the safety devices. This can be for instance activation of the obstacle warning display 30, or in case of falling below a certain minimum distance between the automobile 32 and the obstacle 16 and a crash happens, this can be the release for activating and/or adapting the release threshold of the control device for releasing the airbag 38 and the belt tensioner 28.

Here, it is essential that the information obtained by evaluating the polarization of the reflected laser beam 18 for a safety system in a motor vehicle for example in terms of the type and nature of the obstacle can further improve automotive passenger protection systems with regard to safety criteria.

Reference Numerals

10 Laser (signal source)
12 Laser beam
14 Receiving diode with upstream polarization filter
16 Obstacle
18 Reflected laser beam
20 Evaluation processor
22 Evaluation signal
24 Control unit of the automotive safety device
25 Comparison circuit
26 Airbag control system
27 Threshold value
28 Belt tensioner
30 Obstacle warning display
32 Automobile
34 Safety belt
36 Car passenger
38 Airbag

1-24. (canceled)

25. A device for object recognition, the device comprising:
a signal source (10), adapted to generate at least one electromagnetic wave (12) which may be reflected by an object;
a receiver (14) for receiving the at least one electromagnetic wave (18) reflected by the object (16); and
an evaluation unit, wherein the evaluation unit is provided to evaluate a polarization of the at least one electromagnetic wave (18) reflected by the object(16) and received by the receiver (14) and to generate at least one evaluation signal (22).

26. A device according to claim 25, wherein the evaluation unit (20) is adapted to determine a rotation angle of the polarization between the at least one electromagnetic wave (18), reflected by the object (16) and received by the receiver (14) and an electromagnetic wave emitted by the signal source.

27. A device according to claim 25, wherein the evaluation unit (20) is adapted to determine a type of polarization of the at least one electromagnetic wave (18) reflected by the object (16) and received by the receiver (14).

28. A device according to claim 25, wherein the evaluation unit (20) is adapted to determine a wavelength of the at least one electromagnetic wave (18) reflected by the object (16) and received by the receiver (14).

29. A device according to claim 25, wherein the signal source (10) is adapted to change at least one of an angle of polarization, a level of polarization and a type of polarization of the generated at least one electromagnetic wave (12), in order to generate at least two differently polarized electromagnetic waves (12).

30. A device according to claim 25, wherein the signal source (10) is adapted to change the wavelength of the generated at least one electromagnetic wave (12), in particular to generate at least two electromagnetic waves (12) with different wavelengths.

31. A device according to claim 30, wherein the evaluation unit (20) is adapted to determine on a basis of the evaluated polarization, to evaluate the properties of polarization of at least two electromagnetic waves with different wavelengths, to evaluate the ratio of the two electromagnetic waves.

32. A device according to claim 31, wherein the device is provided in a safety system of vehicle, and the evaluation unit (20) is adapted to generate as an evaluation signal (22) an information signal for controlling a passenger protection system (24, 26, 28, 30) on a basis of information on a determined surface of the object.

33. A device according to claim 32, wherein a control unit (24) of the passenger protection system includes a comparison unit (25), which compares the evaluation signal (22) with a threshold value (27), the control unit (24) being adapted to trigger at least one safety device (26, 28, 30) when the evaluation signal (22) exceeds the threshold value (27).

34. A device according to claim 33, wherein the control unit (24) of the passenger protection system is adapted to change the threshold value (27) dependent on the evaluation signal (22).

35. A device according to claim 25, wherein the device is used in a pre-crash-system, a cV-system, an ADC-system a warning system for obstacle and/or slippery ice and/or a recognition system for roadway conditions.

36. A device according to claim 25, wherein the receiver (14) is adapted to change its receiving characteristics controlled by the evaluation unit (20).

37. A device according to claim 25, wherein the signal source (10) is adapted to generate at least one linear, circular or elliptically polarized electromagnetic wave, having a wavelength in the region of visible light.

38. A method of object recognition comprising:
generating and emitting at least one electromagnetic wave, wherein the at least one electromagnetic wave may be reflected by an object;
receiving at least one electromagnetic wave reflected by the object;
evaluating a polarization of the received electromagnetic wave; and
generating an evaluation signal based on the evaluation of the received electromagnetic wave.

39. A method according to claim 38, wherein a rotation angle of the polarization between the at least one electromagnetic wave (18), reflected by the object (16) and received and emitted, is determined.

40. A method according to claim 38, wherein a type of polarization of the at least one electromagnetic wave (18), reflected by the obstacle (16) and received, is determined.

41. A method according to claim 38, wherein a wavelength of the at least one electromagnetic wave (18), reflected by the object (16) and received, is determined.

42. A method according to claim 38, wherein at least one of an angle of polarization, a level of polarization and a type of polarization of the generated at least one electromagnetic wave (12) is changed, wherein two or more electromagnetic waves (12) having polarizations different from each other are emitted.

43. A method according to claim 38, wherein a wavelength of the generated at least one electromagnetic wave (12) is changed, wherein two or more electromagnetic waves (12) having wavelengths different from each other are emitted.

44. A method according to claim 38, wherein on the basis of the evaluated polarization a surface structure of the object is determined.

45. A method according to claim 44, wherein the method is used in a vehicle passenger protection system and on the basis of information on the determined surface structure the passenger protection system (24, 26, 28, 30) is controlled.

46. A method according to claim 38, wherein at least one of emitting characteristics when emitting and receiving characteristics when receiving the at least one electromagnetic wave (18) reflected by the object (16) is changed.

47. A method according to claim 38, wherein at least one linear, circular or elliptically polarized electromagnetic wave, having a wavelength in the region of visible light, is generated.

48. A method according to claim 38, wherein a non-polarized electromagnetic wave is emitted and its reflection at the object is analyzed with regard to properties of polarization portions and directions contained in the reflected wave, and information thus obtained is compared with stored information on polarizations of reflected waves at certain materials.
